(19) United States
(12) Patent Application Publication
(10) Pub. No.: US 2007/0107045 A1
(43) Pub. Date: May 10, 2007

(54) Security system for transactions

(75) Inventors: Richard H. Selinfreund, Terre Haute, IN (US); Craig S. Etchegoyen, Irvine, CA (US)

Correspondence Address: KELLEY DRYE & WARREN LLP, 400 ATLANTIC STREET, 13TH FLOOR, STAMFORD, CT, 06901, US

(73) Assignee: UNILOC/VERILOC, LLC, Irvine, CA (US)

(21) Appl. No.: 11/520,138

(22) Filed: Sep. 13, 2006

Related U.S. Application Data
(60) Provisional application No. 60/716,740, filed on Sep. 13, 2005.

(51) Int. Cl. H04L 9/32

(52) U.S. Cl. 726/3

(57) ABSTRACT

Systems and methods for confirming the authorization of a person seeking tomake a transaction over a computer network system using algorithms to determine whether a digital recording medium has a fingerprint associated with a medium permitted to allow a transaction to validly occur.

### RELATED APPLICATIONS

This application claims priority to U.S. Provisional Patent Application No. 60/716,470 filed Sept. 13, 2005. The disclosure of each such application is hereby incorporated by reference in its entirety where appropriate for teachings of additional or alternative details, features, and/or technical background, and priority is asserted from each.

### BACKGROUND OF THE INVENTION

1 . Field of the Invention

The present invention generally relates to an authorization technique for transactions employing transportable media marked with a material detectable through a medium reader.

2. Description of the Related Art

Many transactions today occur over public networks such as the Internet and wireless networks. For example, E-commerce catalog shopping represents an increasing part of the economy, with shopping for goods and services using a personal computer being seen as a natural extension to more traditional catalog shopping. Further, banking and bill payment often is performed over such networks as it reduces the need for individuals to spend time by going to a bank or paying their bills manually. Likewise, points are redeemed by consumers over such networks.

While credit and debit cards facilitate purchases and payments made over networks, unauthorized persons continue to penetrate security measures to gain access to financial data, social security numbers and other personal information that allow them to transaction financial transactions on another person's account. For example, once a dishonest person has a credit card number, thousands of dollars can be improperly charged to the customer's credit card account.

Many systems and methods have been devised to detect unauthorized financial transactions made over a computer system. Many of these technique employ a well known encryption technique known as the private-public key system in which information is sent and confirmed. Most encryption schemes require the use of an encryption key that is known only to the party encrypting information and to the intended recipient of the information who will decrypt it. While it is possible to embed an encryption key in an application designed to take an order and transmit it over a network, the embedded encryption key can be discovered by others who may then misuse it.

While many systems have been useful in reducing the unauthorized use of credit or debit lines, invalid transactions still plague the industry. There is a need, therefore, for an improved technique for reducing unauthorized financial transactions over a computer system.

### DEFINITIONS

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a data read.

“Digital Reader”: any device capable of detecting and reading digital information that has been recorded on an Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. A digital recording medium includes, without limitation, CDs, DVDs, HD-DVDs, electromagnetic tape and disks, flash drives and Optical Medium. Information stored on the medium may include, without limitation, software programs, software data, audio files and video files.

“Digital Recording Medium Fingerprint”: identifying information associated with a digital recording medium that can be used to differentiate the digital recording medium from other digital recording mediums.

“Digital Recording Medium Unique Fingerprint”: identifying information uniquely identifying a digital recording medium from other digital recording mediums associated with the physical structure of a digital recording medium. Such information may be recorded in physical indicia associated with the digital recording medium (e.g., material selectively placed on the medium, non-standard data indicia, and/or errors selectively placed on the medium or latent artifacts and errors in the encoding process of the medium or produced by a structure associated with the digital recording medium (e.g., chip, RFID, etc.))

“Light-Activated State-Change Material”: a State-Change Material that alters a measurable state function upon application of a wavelength, or subwavelength, of light or application of photonic energy to the material.

“Optical Medium”: a medium of any geometric shape (not necessarily circular) that is capable of storing indicia or content that may be read by an optical reader.

“Optical Digital Recording Medium”: an optical medium that is capable of storing capable of storing information in digital form thereon.

“Optical Reader”: a Reader (as defined below) for the reading of Optical Medium and Optical Digital Recording Medium.

“Permanent State-Change Material”: a State-Change Material that once activated to change a measurable state function upon application of energy to the material, stays in such state permanently or for a prolonged period of time.

“Processing Device Fingerprint”: identifying information associated with a processing device that can be used to differentiate such processing device from another processing device (e.g., RAM/ROM capabilities, speed, operating system).

“Processing Device Unique Fingerprint”: identifying information which uniquely identifies such processing device from all other processing devices (such as encrypted data on a storage disc associated with the processing device).

“Short Temporary State-Change Material”: a state-change material that, once activated to change a measurable property of the material spontaneously, changes in a short period of time (one hour or less) so as to lose such change in the measurable state.

“State-Change Material”: a material capable of altering a measurable property of the material upon activation of the material by application of energy to the material. By “state change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material spontaneously in a short period of time (minutes or less), loses such change in the measurable property. It includes, without limitation, materials that move from a first state to a second state upon application of energy, and back to the first state without application of energy, which movement in state may reoccur upon reapplication of energy.

“Transportable Digital Recording Medium”: a relatively small medium capable of being transported by hand from one location to another. It includes, without limitation, an optical disc, a floppy disk, a flash drive.

For the purpose of the rest of the, disclosure, it is understood that the terms as defined above are intended, whether such terms are in all initial cap or not.

### SUMMARY OF THE INVENTION

The present invention provides systems and methods for confirming the authorization of a person of seeking to make a transaction over a computer network system, in particular a public network, which makes use of a digital recording medium marked with a material in a identifiable manner (advantageously uniquely identifiable), algorithms for detecting such material on said optical recording medium, and algorithms for detecting the fingerprint of the processing device and/or optical reader upon which optical recording medium is read. The transaction is allowed if the medium and fingerprint are both found to be authorized in conjunction with one another. By “transaction,” it is meant to include, without limitation, financial transactions (e.g., buying, selling, posting funds, removing funds, redeeming points), security transactions (e.g., obtaining access (physical or virtual)), legal transactions (e.g., acceptance of agreements associated with conditions precedent to use of a website), internet transactions (e.g., permitting receipt of emails).

In one embodiment, there is disclosed a method for authenticating a transaction over a network, the method comprising: reading on a portal in a network system a digital recording medium having a digital recording medium unique fingerprint; detecting the fingerprint on the digital recording medium and determining whether the fingerprint is associated with an medium authenticated for making a transaction; determining whether the portal is a portal authorized from which one may make a transaction; permitting a transaction to be made if a digital recording medium unique fingerprint associated with the digital recording medium is authenticated as one allowed to make the transaction and the portal is an authorized portal for the transaction.

In another embodiment, there is disclosed a system for authenticating a transaction over a network, the system comprising: a digital recording medium having a digital recording medium unique fingerprint; a processing device connected to the network, the processing device operatively configured to read the digital recording medium and to detect the digital recording medium unique fingerprint; a database accessible by the processing device, the database comprising one or more digital recording medium fingerprints authenticated for one or more specified transactions; software associated with the network, the software operatively configured to permit a transaction only upon receipt of signal(s) of a digital recording medium fingerprint found in the database to be authenticated for the transaction.

In yet another embodiment, there is disclosed a computer-readable data transmission medium containing a data structure comprising: a first portion identifying the unique digital recording medium fingerprint of a digital recording medium; a second portion identifying a processing device unique fingerprint upon which the digital recording medium was read.

In one embodiment, there is disclosed a method in a computer system for communicating with a computer upon which a user is proposing to conduct a transaction, the method comprising: receiving a uniform resource locator along with a digital recording medium fingerprint; in response to receiving the uniform resource locator and digital recording medium fingerprint determining whether the digital recording medium fingerprint matches fingerprints stored as fingerprints authorized for requested transaction, and if so permitting the computer to transact the transaction.

### DETAILED DESCRIPTION OF THE INVENTION

In one embodiment, the present invention uses digital recording medium (e.g., an optical digital recording medium having a digital recording medium unique fingerprint associated with the digital recording medium and to allow a transaction to proceed if the digital recording medium unique fingerprint is discerned to be associated with a digital recording medium authorized for such transaction). Permission to conduct the transaction may optionally depend upon the authorized digital recording medium also being read on a processing device having a processing device fingerprint, or a processing device unique fingerprint, associated with a processing device authorized for such transaction.

In a further embodiment, the digital recording medium is marked with a material capable of being read by a digital recording medium reader attached to a computer system. Algorithms may be designed to detect the marks on the digital recording medium so as to determine the authenticity of the medium. For consummation of the transaction, fingerprinting the computer system and/or digital reader upon which the digital recording medium is read may also be required. Upon confirmation that an authorized medium has been read, and/or the fingerprint of the computer upon which it is read is also an authorized portal for the transaction, the transaction may be allowed. In an optional embodiment, the fingerprint of the digital recording medium and/or processing device is determined at multiple points in time with the transaction being interrupted at any point in time (up to consummation of the transaction) in which the fingerprint of the digital recording medium and/or processing device is not detected or is detected as changed or altered.

In yet a further embodiment of the invention, the digital recording medium is a transportable digital recording medium such as an optical digital recording medium having thereon a state-change material (which may be, for example, a short temporary state-change material or a transient state-change material), such as a light-activated state-change material. The state-change material is placed on such digital recording medium in a manner so as to encode the disc. Placement of the material may be anywhere on the medium where it may be read. The material preferably is activatable by energy produced by the reader as the reader interrogates the area where the material is located. Detection of the material may be by any means, for example, detection of the material by measuring a parameter of the material, a change in a parameter of the material, or an effect of the material on its milieu. The state-change material may be advantageously placed in manner in respect of the digital datum indicia, such as the pits and lands on a DVD or CD, so as to cause a change in the data read from one read to another read (such as from one valid read to another valid read, from a valid to an invalid read, from a valid to a correctable (by the medium's correction algorithms) invalid read, from a valid to an uncorrectable invalid read). An algorithm may then be applied to cause the reader of the digital recording medium to detect the material on the medium, as for example by detecting the change in data reads when a transient state change material is used.

In one aspect of such embodiments, the algorithm is found on the medium itself. Alternatively, such algorithms may be provided by a source distinct from the medium. For example, such algorithms may be found associated with hardware of a computer or a network location remote from the hardware/medium. Then again, such algorithms may be found in a combination of such places. Such algorithm confirms the authenticity of the medium. This or other algorithms may also fingerprint the reader and/or computer to determine if the transaction is coming from an authorized portal. Again, such algorithm fingerprinting may be found on the medium itself in the hardware or in a source remote from the hardware/medium.

In an embodiment of the invention, a person who seeks to make transactions over a network is provided a medium with a fingerprint so as to identify it as a authorized medium for making transactions. Such fingerprint may be unique to the system itself to uniquely identify the particular medium being used. Optionally, upon reading of such medium by a reader electronically associated with a processing device, an algorithm may be enacted which fingerprints the processing device and/or reader as to identify the processing device and/or reader as an authorized portal for making a transaction with the fingerprinted medium. An authorized fingerprint of the portal may be stored on the medium itself, at the transacting institute or at any site which may be queried through the network. The medium material fingerprint may also be stored at any of these sites.

In one aspect, the algorithms provides more than one portal to be authorized (i.e. allows more than one reader/processing device, such as a computer or a cell phone having a medium reader, etc.) for use of making transactions with the medium. Fingerprinting of the portal may employ, for example, measurable parameters with respect to the operating system of the portal, the configuration of portal (CPU, interleave value, etc) which may or may not uniquely identify the portal (although unique identification may improve authentication).

In yet another embodiment, the locking algorithms for determining whether a medium carries a fingerprint which allows a transaction to be made, and if needed for the transaction, the locking algorithms for assuring that only authorized portals are used in making a transactions, are stored on the medium itself, such as the digital recording medium. When the algorithms find, for example, that both the computer and medium are authorized for a transaction, the transaction is allowed.

When material is used to form the fingerprint, the material may be applied in or on the medium, or in association therewith (for example, on a label). For example, the material may be applied to a hardcoat that is applied to the medium, for example, when the medium is an optical digital recording medium.

In one embodiment, a state change material such as a light-activated state-change material, for example an transient optical state-change material, is applied to an optical digital recording medium (readable by an optical reader attached to a processing device, such as a computer terminal) as a fingerprint in a manner to cause change in the digital read of digital datum indicia on the medium. A locking algorithm on the medium, or which is provided by another source, checks to detect that the light-activated state change material is located in authorized positions on medium so as to act as an authorized medium for consummating a transaction. The locking algorithm (or other algorithm thereon) next checks to determine whether the computer system, or reader/processor system, has the fingerprint that is associated with a system that is authorized to be used in conjunction with that particular marked medium for permitting a transaction. If both the portal system and medium are not detected as being authorized, the transaction is not permitted. As indicated above, it is also in purview of the present invention that either or both locking algorithms may be stored other than on the medium, for example, elsewhere in the network.

The present invention thus allows the medium to be used to authenticate an financial transaction in a manner that is not done when traditional credit and/or debit card information is sent over a public network. In this sense, the medium may be said to be acting as the credit and/or debit card. By requiring an inquiry of the actual medium and/or processing device upon which the medium is read to eventuate in a valid fingerprint for the transaction to occur, simple knowledge of a code (such as a credit card number) is not enough for the transaction to occur.

As would also be understood, the processing device of the present invention may or may not be a personal computer. For example, the processing device may be a chip located on the medium, the processor of a cell phone, the processor of a blackberry device etc. It should be also understood, that the locking algorithms and/or fingerprints may be stored in electronic storage such as in a processing device associated with the medium, rather in digital indicia itself.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. A method for authenticating a transaction over a network, said method comprising:
reading on a portal in a network system a digital recording medium having a digital recording medium unique fingerprint;
detecting the fingerprint on the digital recording medium and determining whether said fingerprint is associated with an medium authenticated for making a transaction;
determining whether said portal is a portal authorized from which one may make a transaction;
permitting a transaction to be made if a digital recording medium unique fingerprint associated with the digital recording medium is authenticated as one allowed to make the transaction and the portal is an authorized portal for such transaction.

2. The method of claim 1 wherein the digital recording medium unique fingerprint comprises detectable material found at one or more positions on the medium.

3. The method of claim 2 wherein the detectable material is a state-change material.

4. The method of claim 3 wherein the state-change material is temporary state-change material.

5. The method of claim 3 wherein the state-change material is a permanent state-change material.

6. The method of claim 3 wherein the state-change material is a short temporary state-change material.

7. The method of claim 3 wherein the state-change material is a transient state-change material.

8. The method of claim 1 wherein the digital recording medium unique fingerprint is stored in a chip in or on said digital recording medium.

9. A system for authenticating a transaction over a network, said system comprising:
a digital recording medium having a digital recording medium unique fingerprint;
a processing device connected to said network, said processing device operatively configured to read said digital recording medium and to detect said digital recording medium fingerprint;
a database accessible by said processing device said database comprising one or more digital recording medium fingerprints authenticated for one or more specified transactions;
software associated with the network, said software operatively configured to permit a transaction only upon receipt of signal(s) of a digital recording medium unique fingerprint found in said database to be authenticated for such transaction.

10. The system of claim 9 wherein the processing device has a fingerprint.

11. The system of claim 10 wherein said database further comprises at least one processing device fingerprint associated with each digital recording medium fingerprint.

12. The system of claim 11 wherein said software is further configured to permit transaction only if the processing device has a fingerprint associated in said database as authenticated for such transaction.

13. The system of claim 9 wherein the digital recording medium fingerprint is a unique fingerprint.

14. The system of claim 10 wherein the processing device fingerprint is a unique fingerprint.

15. A computer-readable data transmission medium containing a data structure comprising:
a first portion identifying the digital recording medium unique fingerprint of a digital recording medium;
a second portion identifying a processing device unique fingerprint upon which the digital recording medium was read.

16. A method in a computer system for communicating with a computer upon which a user is proposing to conduct a transaction, the method comprising:
receiving a uniform resource locator along with a digital recording medium fingerprint;
in response to receiving the uniform resource locator and digital recording medium fingerprint determining whether the digital recording medium fingerprint matches fingerprints stored as fingerprints authorized for requested transaction, and if so permitting the computer to transact the transaction.
